(19) United States
(12) Patent Application Publication
(10) Pub. No.: US 2009/0103317 A1
(43) Pub. Date: Apr. 23, 2009

(54) Portable service light

(76) Inventors: Raymond E. Steck, Miamisburg, OH (US); Laurence D. Steck, Dayton, OH (US); Frederick S. Patton, St. Paris, OH (US); John R. Brill, Kettering, OH (US)

Correspondence Address: Joseph G. Nauman, 696 Renolda Woods CT., Dayton, OH, 45429-3415, US

(21) Appl. No.: 11/974,991

(22) Filed: Oct. 17, 2007

(51) Int. Cl. F21V 21/092

(52) U.S. Cl. 362/397

(57) ABSTRACT

A portable lamp including at least one light source and a body having a generally symmetrical bowl-like inner surface and a rim on said inner surface, said rim extending about a central axis that is perpendicular to a plane intersecting said rim, said light source being supported in said body to project a beam away from said inner surface such that the light beam is directed at an angle to the central axis and through said rim of the body, whereby the direction of the beam beyond said rim may be controlled by rotating said body about the central axis and effectively scanning the beam in a cone-like pattern extending outward of said rim. The body is constructed as a suction holding device by having at least the immediate edge of the body surrounding the rim made of a flexible material so the rim can then be pressed against a substantially rigid window pane or the like supported in a window of a structure, to create a negative pressure sufficient to hold the lamp on the pane. The interior surface of the dome-like part of the body may be light reflective to function as a reflector and assisting in directing emitted light.

### SUMMARY OF THE INVENTION

A portable lamp, preferably self-supportable on a window or the like, includes one or more light sources (such as LED) supported upon or within a bowl-like body having a rim and a generally symmetrical bowl-like inner surface extending about a central axis that is perpendicular to a plane intersecting such rim. The light source in the lamp projects a beam, or closely packed beams, out of the inner surface such that the light beam(s) is directed at an angle to the central axis through the open rim of the body and, if desired, through a window. The direction of such beam(s) may be modified by rotating the body about the central axis, effectively scanning the beam(s) in a cone-like pattern, and if desired holding the body in a selected location. Thus, the lamp makes it possible to perform a unique method of lighting the interior of a darkened space through a window or the like.

### BRIEF DESCRIPTION OF THE DRAWINGS

FIG. 1 is a pictorial view of the lamp provided by the invention being used to illuminate an interior space within a vehicle;

FIG. 2 is an exterior side view of the lamp;

FIG. 3 is a cross-sectional view through the lamp as shown in FIG. 2;

FIG. 4 is a top view of the lamp; and

FIG. 5 is an external side view of the lamp as seen from the bottom of FIG. 4.

### DESCRIPTION OF A PREFERRED EMBODIMENT

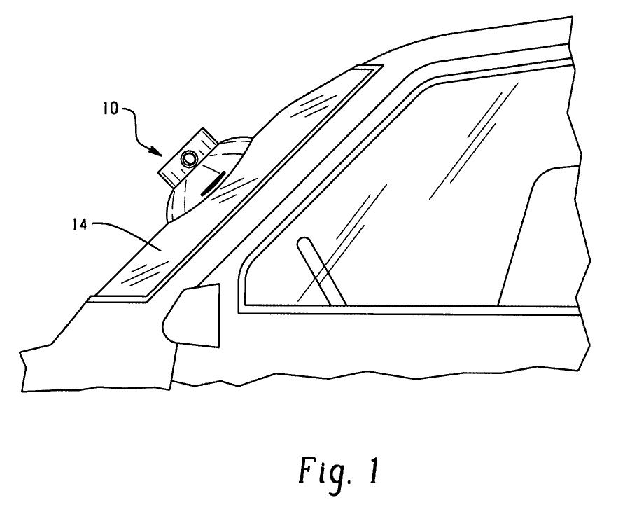

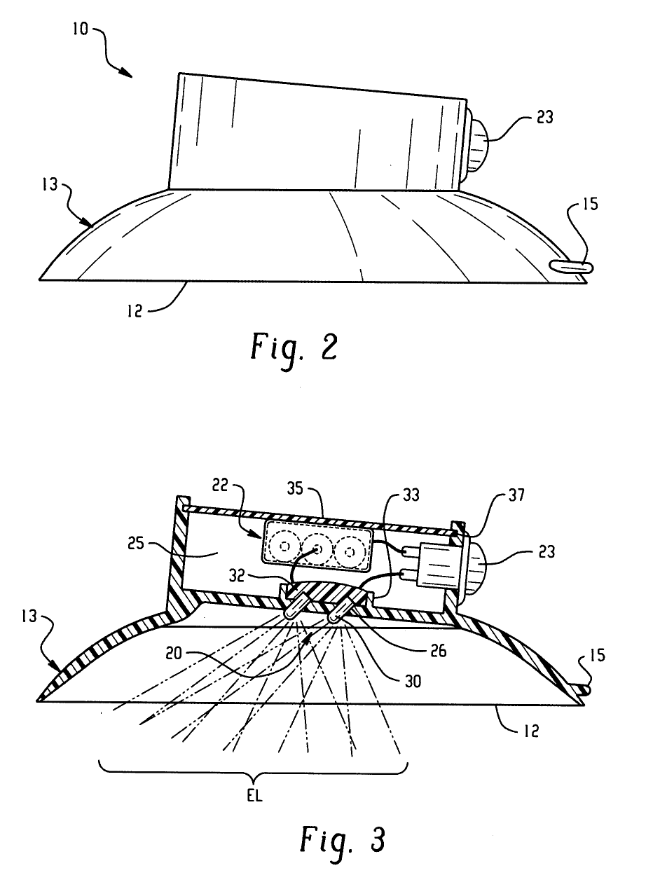

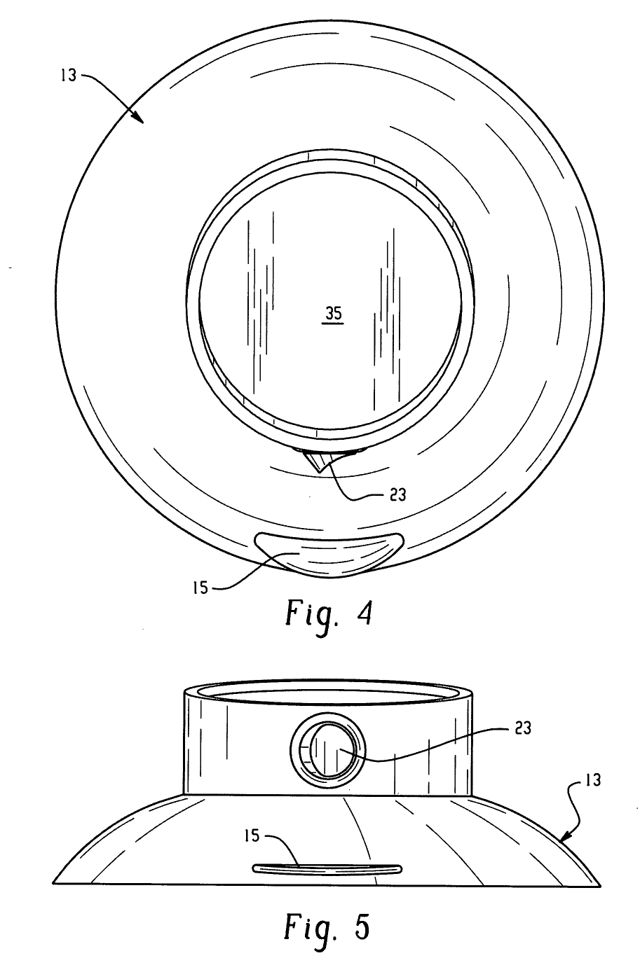

The body 10 of the lamp can be constructed as a suction holding device by having at least the immediate edge of the body surrounding the rim 12 made of a flexible material. The lower part 13 of body 10 can then be pressed against a pane of glass 14, (e.g. a vehicle windshield or other window {FIG. 1}, the exterior of a window in a building, etc.), with rim 12 totally in contact with the pane 14. Then, by pressing the lamp body against pane 14, sufficient air is evacuated from inside the dome-like lower part 13 of body 10 such as to create a negative pressure (i.e. suction) sufficient to hold the lamp in a selected position. When desired, this suction can be released by lifting the integral handle 15 (FIGS. 2, 4 and 5) to pull a portion of the rim 12 away from the glass 14. The interior of the dome-like lower part 13 of body 10 may function as a reflector to assist in directing light emitted from light source 20

The light source 20, and preferably also the power source 22 and a control switch 23, are mounted (and preferably sealed) in the upper compartment portion 25 which is preferably an integral part of lamp body 10. When body 10 is placed with its rim 12 against a window surface, with control switch 23 is in its ON position, the beam (or closely spaced beams) EL of emitted light passes through the window glass at a given angle.

A preferred light source 20 is a plurality of LEDs 30 wired to battery power source 22 and switch 23, and potted into a block 32 which is sealed into a shallow trough 33 in the bottom of upper compartment 25; the trough 33 defines the alignment of the LEDs in block 33. The tips of the LEDs are located within and sealed to small holes 26 in the bottom of trough 33 that open into the top of lower body part 13. When power is connected to the LEDs, the beams emitted from each of them combine to provide a larger beam EL directed through and out of lower body part 13.

This beam EL is at a predetermined angle with respect to a plane defined by rim 12, and can be scanned or swept through the space on the opposite side of the window surface simply by rotating the lamp body in place and, when desired, re-positioning the body against the glass.

For example, if the reflector is placed against a vehicle windshield, as depicted in FIG. 1, the light beam, which will spread somewhat over a distance, can be directed against (in particular) lock mechanisms on either door interior within the vehicle, or scanned about the interior of a darkened room. The description of this use of the lamp is not intended to be limiting, but simply defines one of a variety of uses and/or situations where this unique lamp has utility; It can be used to inspect the interiors of vehicles in darkness, for example to locate a lock-release switch or button, or similarly, to view interiors of darkened buildings, or to provide a relatively light-weight but powerful hand-held lamp while trying to inspect the premises about a vehicle accident scene or a vehicle temporarily abandoned (e.g. break-down).

In a preferred embodiment of the light the interior of the dome-like lower body, or for that matter its entire exterior, can be molded of a suitable polymer having a bright colored light reflective surface; this reflective surface can be limited to the dome-like interior or provided throughout the molded part.

As illustrated in FIG. 3 the integral upper compartment 25 can be molded onto the exterior (top) of the dome-like lower body, so as to incorporate in such upper compartment one or more light sources such as several light emitting diodes (LEDs) 30 that are potted together and incorporated in the compartment with the tips of the LEDs aligned with small apertures 32 in the interior upper dome surface The on-off electrical toggle switch 23 is fitted into a sidewall of the compartment with its control button extending through, or into, the sidewall. The switch is appropriately wired to the LEDs and to power source 22 (a battery box) that is integral with, or supported on, a cover plate 35 that can be inserted into an internal groove 37 about the top of the upper compartment sidewall, so as to enclose and seal the upper compartment while providing access for replacing batteries, or other servicing.

Thus, the power for the LED light source is contained within a closed, and essentially sealed (at least at atmospheric pressure) compartment separated from the interior of the dome-like light body, and the body together with the exterior of such compartment, may be integrally molded of a desired color of plastic material, and at least the bowl-like inner surface may be light reflective. Checking and replacement of the batteries is readily accomplished without use of tools, by simply prying off the cover plate.

While the method herein described, and the form of apparatus for carrying this method into effect, constitute preferred embodiments of this invention, it is to be understood that the invention is not limited to this precise method and form of apparatus, and that changes may be made in either without departing from the scope of the invention, which is defined in the appended claims.

What is claimed is:

1. A portable lamp including at least one light source and a body having a generally symmetrical bowl-like inner surface and a rim on said inner surface, said rim extending about a central axis that is perpendicular to a plane intersecting said rim, said light source being supported in said body to project a light beam away from said inner surface such that the light beam is directed through said bowl-like inner surface and through said rim of the body.

2. A portable lamp as defined in claim 1, wherein said light source is supported in said body to project a light beam away from said inner surface such that the light beam is directed at an angle to the central axis and through said rim of the body, whereby the direction of the beam beyond said rim may be controlled by rotating said body about the central axis and effectively scanning the beam in a cone-like pattern extending outward of said rim.

3. A lamp as defined in claim 1, wherein said body is constructed as a suction holding device by having at least the immediate edge of the body surrounding the rim made of a flexible material, whereby said rim can then be pressed against a substantially rigid pane of an at least translucent material supported in a window of a structure to evacuate sufficient air from inside said dome-like part of body to create a negative pressure sufficient to hold said lamp in a selected position on the pane.

4. A lamp as defined in claim 1, wherein
the interior said interior surface of said bowl-like inner surface of said body is light reflective so as to function as a reflector assisting in directing light emitted from light source.

5. A lamp as defined in claim 1, wherein
a separate compartment portion formed on said body adjacent said light source dome like part, and
a power source for said light source in said separate compartment, and a control switch connected to said light source and power source to control illumination of said light source; said control switch being housed in said body and actuatable from the exterior of said map body.

6. The method of illuminating the interior of an enclosure by directing a beam of light through a window-like opening in the enclosure, including
providing a portable lamp including a light source supported in a body having a generally symmetrical bowl-like inner surface with a rim, the light source being arranged to direct a beam of light from the lamp source at a predetermined angle to the rim,
placing the rim of the lamp body at the window-like opening to project a beam away from said inner surface such that the light beam is directed through the window-like opening into the enclosure,
whereby the direction of the beam of light beyond said rim may be controlled by rotating the body to scan the beam in a cone-like pattern extending outward of the rim.

7. The method defined in claim 6, wherein said body is constructed as a suction holding device by having at least the immediate edge of the body surrounding the rim made of a flexible material, whereby the rim can then be pressed against a substantially rigid pane of an at least translucent material supported in the window-like opening to create a negative pressure within the lamp body sufficient to hold the lamp in a selected position on the pane.
